(19) United States
(12) Patent Application Publication
(10) Pub. No.: US 2013/0089111 A1
(43) Pub. Date: Apr. 11, 2013

(54) SYNCHRONIZATION ESTABLISHING METHOD, RECEIVING DEVICE AND TRANSMITTING DEVICE

(71) Applicant: Fujitsu Limited, Kawasaki (JP)

(72) Inventor: Toshiaki OOKUBO, Utsunomiya (JP)

(73) Assignee: FUJITSU LIMITED, Kawasaki (JP)

(21) Appl. No.: 13/688,798

(22) Filed: Nov. 29, 2012

Related U.S. Application Data
(63) Continuation of application No. PCT/JP2010/059464, filed on Jun. 3, 2010.

(51) Int. Cl. H04J 3/06

(52) U.S. Cl. CPC H04J 3/0602
USPC 370/512

(57) ABSTRACT

A synchronization establishing method for establishing frame synchronization in a communication system in which one frame is divided into a plurality of signal blocks, the plurality of signal blocks are transmitted in parallel and after that multiplexed and transmitted as a multiplex signal, and a plurality of signal blocks, acquired by separating the received multiplex signal, are transmitted in parallel and after that combined and formed into a format of the frame, the synchronization establishing method comprising executing a sequence for establishing synchronization of the frame. The sequence comprises inputting synchronization signals in the plurality of signal blocks that are multiplexed in the multiplex signal, detecting the synchronization signals from the plurality of signal blocks that are separated from the multiplex signal, and adjusting a phase of each of the plurality of signal blocks that are separated, based on phases of the detected synchronization signals.

### CROSS-REFERENCE TO RELATED APPLICATIONS

The present application is a continuation application based on International application No. PCT/JP2010/059464, filed on Jun. 3, 2010, the entire contents of which are incorporated herein by reference.

### FIELD

The embodiments discussed herein are related to a frame transmission technique, whereby one frame is divided into a plurality of signal blocks, these plurality of signal blocks are transmitted in parallel and after that multiplexed and transmitted as a multiplex signal, and a plurality of signal blocks, acquired by demultiplexing a received multiplex signal, are transmitted in parallel and after that combined and formed in the format of the frame.

### BACKGROUND

A frame transmission technique has been in use, in which one frame is divided into a plurality of signal blocks, these plurality of signal blocks are transmitted in parallel and after that multiplexed and transmitted as a multiplex signal, and a plurality of signal blocks, acquired by demultiplexing a received multiplex signal, are transmitted in parallel and after that combined and formed in the format of the frame. As an example of this transmission technique, there is a frame transmission technique for transmitting a plurality of signal blocks, which are acquired by dividing a frame that is transmitted and received on an optical channel in parallel in a plurality of lanes, in an electrical signal processing unit. In a transmitting device, one frame is divided into a plurality of signal blocks, these plurality of signal blocks are transmitted in parallel in a plurality of lanes and after that multiplexed to generate an optical signal, and the optical signal is transmitted to an opposing receiving device. In a communication device on the receiving side, a plurality of signal blocks, which are acquired by demultiplexing the optical signal, are transmitted in parallel in a plurality of lanes. After that, in the communication device on the receiving side, these plurality of signal blocks are combined and formed in the format of the frame, thereby reconstructing the frame.

Due to delay differences between a plurality of lanes, phases of signal blocks to be output from the lanes of the communication device on the receiving side are different each other. In addition, a lane of the communication device on the receiving side, from which a signal block that is input into a given lane of the communication device on the transmitting side is output, varies depending on the state of the optical signal. Furthermore, depending on the state of the optical signal, the polarity of the received signal might be inverted. In the following descriptions, a lane of a communication device on the transmitting side may be referred to as “transmitting lane,” and a lane of a communication device on the receiving side may be referred to as “receiving lane.”

To solve the above problem, conventionally, the synchronization establishing technique referred to as “MLD (Multi Lane Distribution)” has been used. In a system that employs MLD, a transmitting device divides a frame into a plurality of signal blocks and inputs the signal blocks in transmitting lanes. When a signal block including the overhead (OH) of the frame is detected in a receiving lane, the receiving device performs phase adjustment and polarity determination with respect to signal blocks that are output from the receiving lanes, using a known pattern that is included in the OH.

The transmitting device stores the identifier of the transmitting lane where the signal block including the OH is input, in the unoccupied area in the OH. When detecting the OH, the receiving device determines signal blocks input to transmitting lanes are output to which receiving lanes, according to the receiving lane where the OH is detected and the identifier of the transmitting lane stored in the OH.

The transmitting device switches, per frame, the transmitting lane to input the signal block picked up from the same position in the frame. Consequently, signal blocks to include the frame OH are distributed to different lanes on a per frame basis.

Examples of distribution to lanes when an OTU (Optical-channel Transport Unit)—4 frame is transmitted, will be illustrated. FIG. 1 is a diagram illustrating an example of an OTU4-frame. The OTU4-frame 100 includes OH 101, ODU-OH (Optical channel Data Unit—Over Head) 102, a payload 103 and an FEC (Forward Error Correction) unit 104. The size of the OH 101 is 16 bytes×1 row, and the size of the ODU-OH 102 is 16 bytes×3 rows. In addition, the size of the payload 103 is 3808 bytes×4 rows, and the size of the FEC 104 is 256 bytes×4 rows.

FIG. 2 is a diagram illustrating an example of division of the OTU4-frame. The OTU4-frame 100 illustrated in FIG. 1 is divided into signal blocks of 51 columns×20 rows, including OH, 1-2 to 1-51, 2-1 to 2-51 . . . 20-1 to 20-51. The size of one signal block is 4 bytes×32 bits. The signal block OH is a signal block including the OH 101 of the OTU4-frame 100.

FIG. 3A to FIG. 3C are diagrams each illustrating a mode to distribute divided frames to lanes. FIG. 3A illustrates a mode to distribute divided signal blocks of an n-th OTU4-frame to the first to twentieth lanes. FIG. 3B and FIG. 3C illustrate modes to distribute signal blocks, into which an (n+1)-th OTU4-frame is divided, and signal blocks, into which an (n+2)-th OTU4-frame is divided, to the first to twentieth lanes.

As illustrated in FIG. 3A, in an n-th frame, the signal block OH and signal blocks 1-2 to 1-51 are input in the first lane, signal blocks 2-1 to 2-51 are input in the second lane, and signal blocks 20-1 to 20-51 are input in the twentieth lane.

As illustrated in FIG. 3B, in an (n+1)-th frame, the signal block OH and signal blocks 1-2 to 1-51 are input in the second lane, signal blocks 2-1 to 2-51 are input in the third lane, and signal blocks 20-1 to 20-51 are input in the first lane. As illustrated in FIG. 3C, in an (n+2)-th frame, the signal block OH and signal blocks 1-2 to 1-51 are input in the third lane, signal blocks 2-1 to 2-51 are input in the fourth lane, and signal blocks 20-1 to 20-51 are input in the second lane.

In this way, signal blocks including OH of the frame are input in different lanes sequentially, on a per frame basis, so that phase adjustment and polarity determination are carried out in all lanes. Furthermore, with respect to all lanes, the correspondence relationships between the transmitting lanes where signal blocks are input and the receiving lanes where signal blocks are output become clear, so that the receiving device reconstructs frames by combining signals output from the receiving lanes according to the correspondence relationships that have become clear.

Moreover, another frame synchronization method has been proposed. The frame synchronization method converts an optical signal, in which the phase, the frequency or the polarization plane is binary-modulated, into two intensity-modulated lights of mutually inverted logic. The method converts at least one of the two intensity-modulated lights into an electrical signal, and establish frame synchronization by retrieving a specific frame synchronization pattern from the electrical signal. According to this method, when it is not possible to detect a specific frame synchronization pattern, a frame synchronization pattern is retrieved in reverse logic.

Related art is disclosed in Japanese National Publication of International Patent Applications No. 2008-92406.

### SUMMARY

According to one mode of an embodiment, a synchronization establishing method for establishing frame synchronization in a communication system in which one frame is divided into a plurality of signal blocks, the plurality of signal blocks are transmitted in parallel and after that multiplexed and transmitted as a multiplex signal, and a plurality of signal blocks, acquired by separating the received multiplex signal, are transmitted in parallel and after that combined and formed into a format of the frame, is provided. The present method executes a sequence for establishing frame synchronization. This sequence includes inputting synchronization signals in the plurality of signal blocks that are multiplexed in the multiplex signal, detecting the synchronization signals from the plurality of signal blocks that are separated from the multiplex signal, and adjusting the phase of each of the plurality of signal blocks that are separated, based on the phases of the detected synchronization signals.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a frame to be transmitted;

FIG. 2 is a diagram illustrating an example of division of a frame;

FIG. 3A is a diagram illustrating a mode to distribute a divided frame to lanes;

FIG. 3B is a diagram illustrating a mode to distribute a divided frame to lanes;

FIG. 3C is a diagram illustrating a mode to distribute a divided frame to lanes;

FIG. 4 is a diagram (pattern 1) illustrating a configuration example of a communication system;

FIG. 5 is a diagram (pattern 2) illustrating a configuration example of a communication system;

FIG. 6 is a diagram illustrating a configuration example of a multi-lane transmitting unit;

FIG. 7 is a diagram illustrating a first example of a configuration of a multi-lane receiving unit;

FIG. 8 is a diagram illustrating a first example of a configuration of a received signal processing unit;

FIG. 9 is a diagram illustrating another configuration example of a transmitting device;

FIG. 10 is a diagram illustrating a first example of a synchronization establishing sequence in a transmitting device on the transmitting side;

FIG. 11 is a diagram illustrating a first example of a synchronization establishing sequence in a transmitting device on the receiving side;

FIG. 12 is a diagram illustrating the first example of a synchronization establishing process in a received signal processing unit;

FIG. 13 is a diagram illustrating a second example of a configuration of a received signal processing unit;

FIG. 14 is a diagram illustrating a second example of a configuration of a multi-lane receiving unit;

FIG. 15 is a diagram illustrating a second example of a synchronization establishing sequence in a transmitting device on the transmitting side;

FIG. 16 is a diagram illustrating a second example of a synchronization establishing sequence in a transmitting device on the receiving side; and

FIG. 17 is a diagram illustrating a second example of a synchronization establishing process in a received signal processing unit.

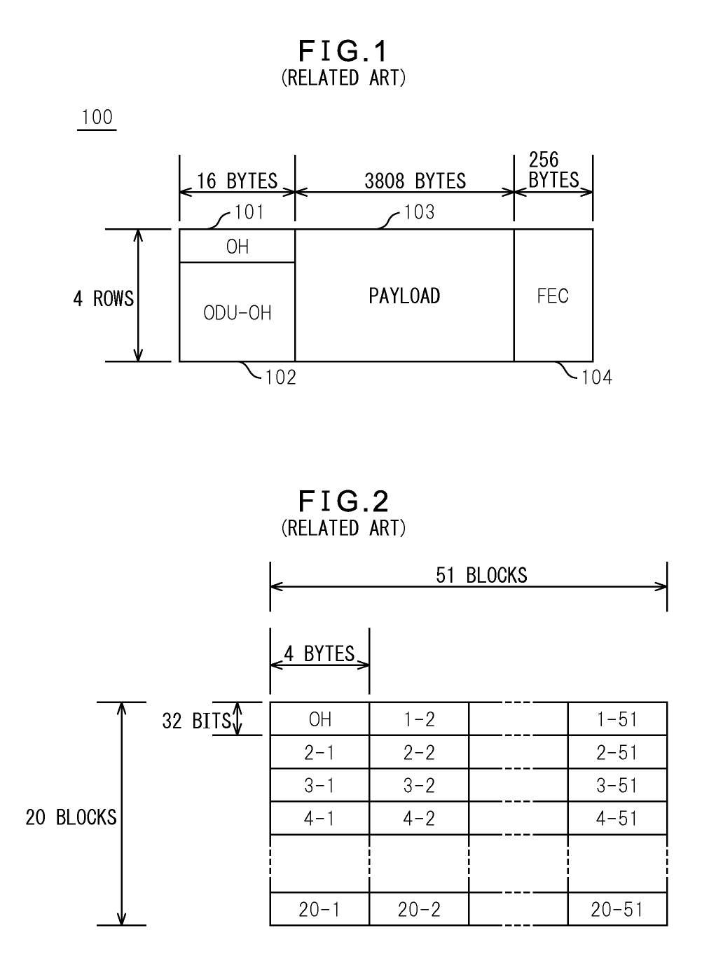

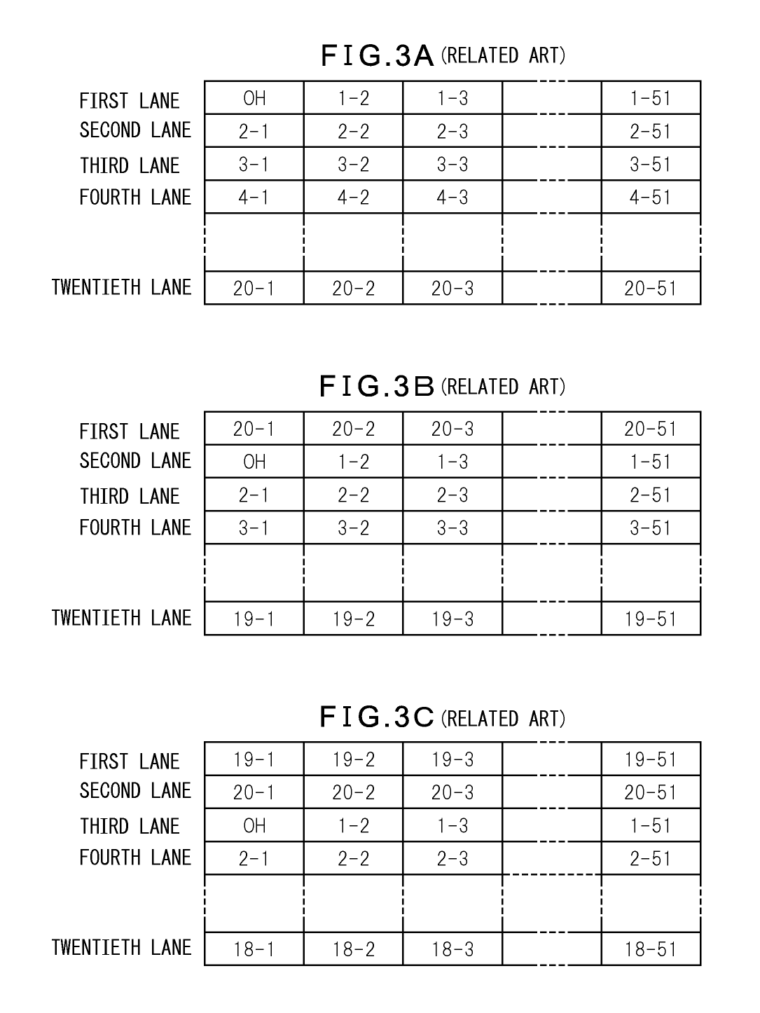

### DESCRIPTION OF EMBODIMENTS

With a conventional synchronization establishing technique, the transmitting lane to input the signal block of the same position in the frame is switched per frame, so that the transmitting lane of the signal block including the OH is switched and the signal block including the OH is transmitted in any lane. Switching of transmitting lanes is made possible by storing frames in a memory on a temporary basis and controlling the address to read the data to be input in each lane. Consequently, the memory to store frames results in an increase in circuit scale in the circuit to be used for frame synchronization.

It is therefore an object of the device and method according to embodiments to reduce the scale of the circuit to be used for frame synchronization, in a communication device in which one frame is divided into a plurality of signal blocks, and these plurality of signal blocks are transmitted in parallel and after that multiplexed and transmitted as a multiplex signal.

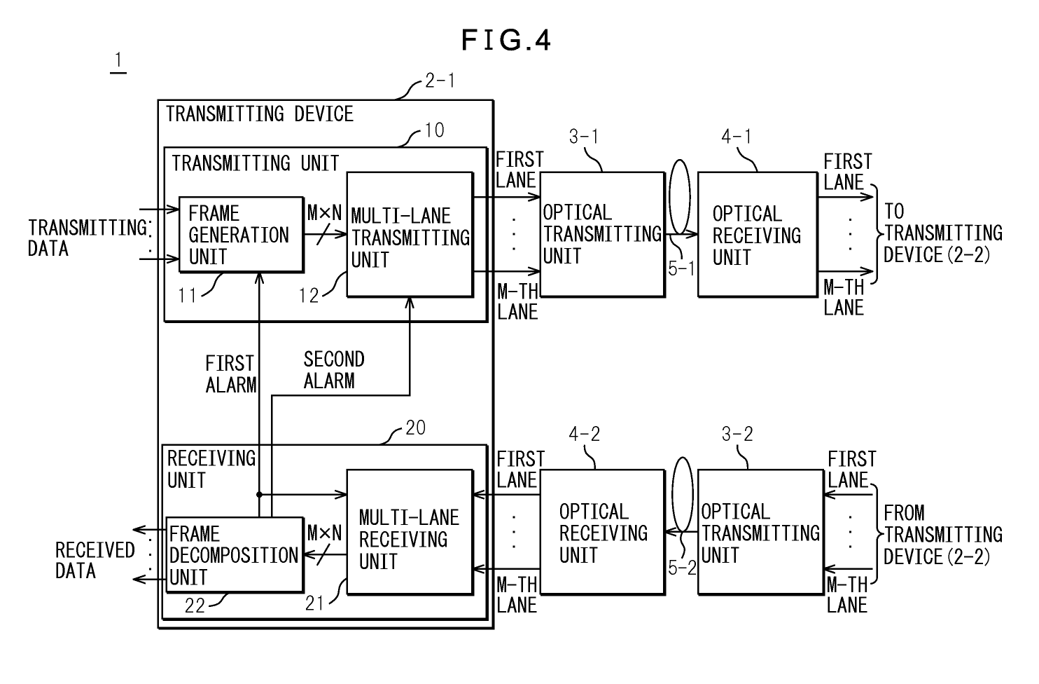

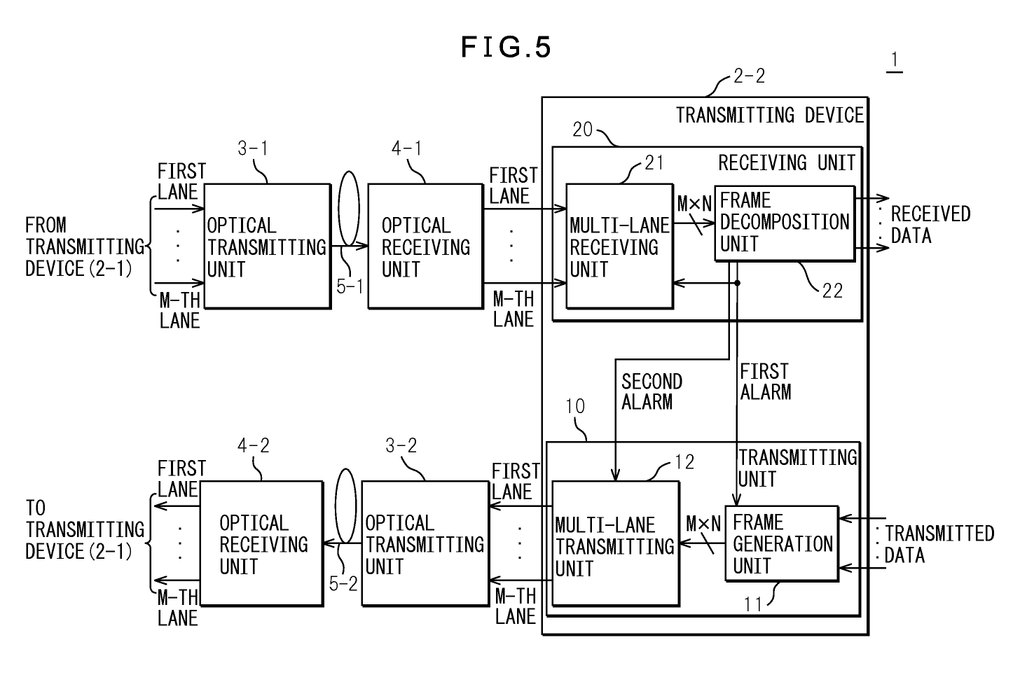

Preferred embodiments will be illustrated below with reference to the accompanying drawings. FIG. 4 and FIG. 5 are diagrams each illustrating a configuration example of a communication system. A communication system 1 includes transmitting devices 2-1 and 2-2, optical transmitting units 3-1 and 3-2, optical receiving units 4-1 and 4-2, and optical channels 5-1 and 5-2.

In the following descriptions, the transmitting devices 2-1 and 2-2 may be collectively referred to as “transmitting device 2.” In the following descriptions, the optical transmitting units 3-1 and 3-2 may be collectively referred to as “optical transmitting unit 3.” In the following descriptions, the optical receiving units 4-1 and 4-2 may be collectively referred to as “optical receiving unit 4.” In the following descriptions, the optical channels 5-1 and 5-2 may be collectively referred to as “optical channel 5.”

The transmitting device 2 generates a frame by multiplexing a plurality of pieces of transmitting data that are input. The transmitting device 2 divides the generated frame into a plurality of signal blocks. In the following descriptions, each of a plurality of signal blocks, acquired by dividing a frame, may be referred to as “partial signal.” The transmitting device 2 distributes the partial signals to the first lane to the M-th lane, which are electrical signal channels. The partial signals are transmitted in parallel on the first lane to the M-th lane, and are input in the optical transmitting unit 3.

The optical transmitting unit 3 multiplexes the partial signals that are received separately in a plurality of lanes, and generates an optical signal as a multiplex signal. The optical transmitting unit 3 transmits the optical signal to the optical receiving unit 4 via an optical channel 5. The optical receiving unit 4 separates the received optical signal by demultiplexing the received optical signal, and acquires a plurality of partial signals included in the optical signal. The optical receiving unit 4 is an example of the separation unit recited in the claims. The optical receiving unit 4 converts the plurality of partial signals into electrical signals and after that distributes the signal blocks to the first lane to the M-th lane. The partial signals are transmitted in parallel on the first lane to the M-th lane and are input in the transmitting device 2.

The transmitting device 2 reconstructs a frame by combining partial signals received from the optical receiving unit 4 to form these partial signals into the format of the frame. The transmitting device 2 outputs a plurality of pieces of received data that are acquired by decomposing the reconstructed partial signals.

The transmitting device 2 includes a transmitting unit 10 and a receiving unit 20 that process electrical signals. The transmitting unit 10 includes a frame generation unit 11 and a multi-lane transmitting unit 12. The receiving unit 20 includes a multi-lane receiving unit 21 and a frame decomposition unit 22.

The frame generation unit 11 generates a frame by multiplexing a plurality of pieces of transmitting data. The frame generation unit 11 outputs the generated frame to the multi-lane transmitting unit 12 as parallel signals having a bit width of M×N bits. The multi-lane transmitting unit 12 divides the received parallel signals into M partial signals each. The partial signals are parallel data having a bit width of N bits. The multi-lane transmitting unit 12 converts the M partial signals into serial data. The multi-lane transmitting unit 12 inputs the M partial signals to the first lane to the M-th lane.

The multi-lane receiving unit 21 converts the format of the M partial signals, which have been received from the optical receiving unit 4 via the first lane to the M-th lane, from a serial format to a parallel format. The multi-lane receiving unit 21 provides the parallel signals, in which M partial signals each having a bit width of N bits are aligned and which therefore have a bit width of M×N bits, to the frame decomposition unit 22 as an input.

The frame decomposition unit 22 reconstructs a frame by combining partial signals received from the multi-lane receiving unit 21 to form these partial signals into the format of the frame. The frame decomposition unit 22 outputs a plurality of pieces of received data that are acquired by decomposing the formed frame. In addition, the frame decomposition unit 22 decides whether or not synchronization of the received frame is established. When the received frame is out of synchronization, the frame decomposition unit 22 outputs the first alarm signal, which indicates that the received frame is out of synchronization, to the frame generation unit 11 and the multi-lane receiving unit 21.

The frame generation unit 11 adds the first alarm signal into a transmitting frame. The frame generation unit 11 may add the first alarm signal into, for example, the OH of the transmitting frame. The frame including the first alarm signal is transmitted to the opposing transmitting device 2.

The frame decomposition unit 22 detects the first alarm signal included in the received frame that is received from the opposing transmitting device 2. When the first alarm signal is detected, the frame decomposition unit 22 outputs a second alarm signal to the multi-lane transmitting unit 12. The multi-lane receiving unit 21 having received the first alarm signal executes the synchronization establishing sequence for establishing frame synchronization. The synchronization establishing sequence will be described below. The multi-lane transmitting unit 12 having received the second alarm signal executes the synchronization establishing sequence.

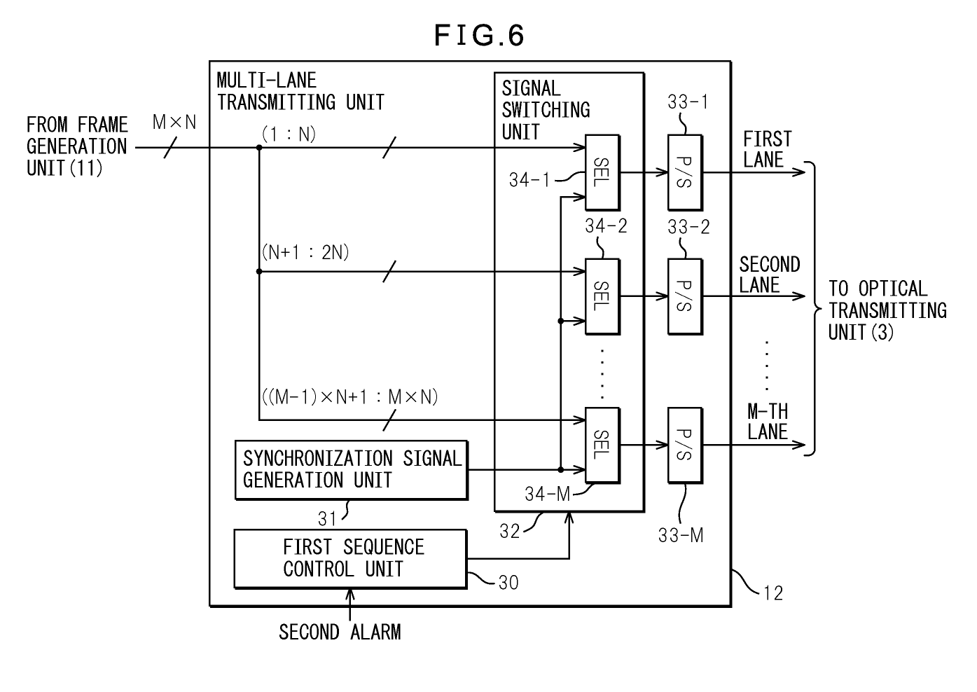

Next, the configurations and processes of the parts of the transmitting device 2 will be illustrated. FIG. 6 is a diagram illustrating a configuration example of the multi-lane transmitting unit 12. The multi-lane transmitting unit 12 includes a first sequence control unit 30, a synchronization signal generation unit 31, a signal switching unit 32, and parallel-to-serial conversion units 33-1 to 33-M. In the drawings and the following descriptions, a parallel-to-serial conversion unit may be referred to as “P/S.” In the following descriptions, the P/Ss 33-1 to 33-M may be collectively referred to as “P/S 33.”

The synchronization signal generation unit 31 generates a synchronization signal, including a known pattern to be used in the synchronization establishing sequence. The synchronization signal may be a dummy frame that includes a known pattern. Furthermore, the synchronization signal may be a training signal that includes a known pattern.

The signal switching unit 32 selects one of the real signal and the synchronization signal and provided the signal to each of the first lane to the M-th lane as an input. The real signal is a partial signal that is acquired in the frame generation unit 11 by dividing a frame including transmitting data that is input in transmitting device 2. The signal switching unit 32 may include, for example, selectors 34-1 to 34-M that select the signals to be input in the first lane to the M-th lane. The signal switching unit 32 provides the synchronization signals into the first lane to the M-th lane, and by this means, the synchronization signals are input in the partial signals that are multiplexed to be an optical signal in the optical transmitting unit 3. In the drawings and the following descriptions, a selector may be referred to as “SEL.” In the following descriptions, the SELs 34-1 to 34-M may be collectively referred to as “SEL 34.”

The P/Ss 33-1 to 33-M convert the signals to be transmitted in the first lane to the M-th lane from a parallel format to a serial format. The first sequence control unit 30 receives the second alarm signal from the frame decomposition unit 22. When receiving the second alarm signal from the frame decomposition unit 22, the first sequence control unit 30 starts the synchronization establishing sequence.

When the second alarm signal stops being received from the frame decomposition unit 22, the first sequence control unit 30 finishes the synchronization establishing sequence. In the synchronization establishing sequence, the signal switching unit 32 provides the synchronization signals into the first lane to the M-th lane.

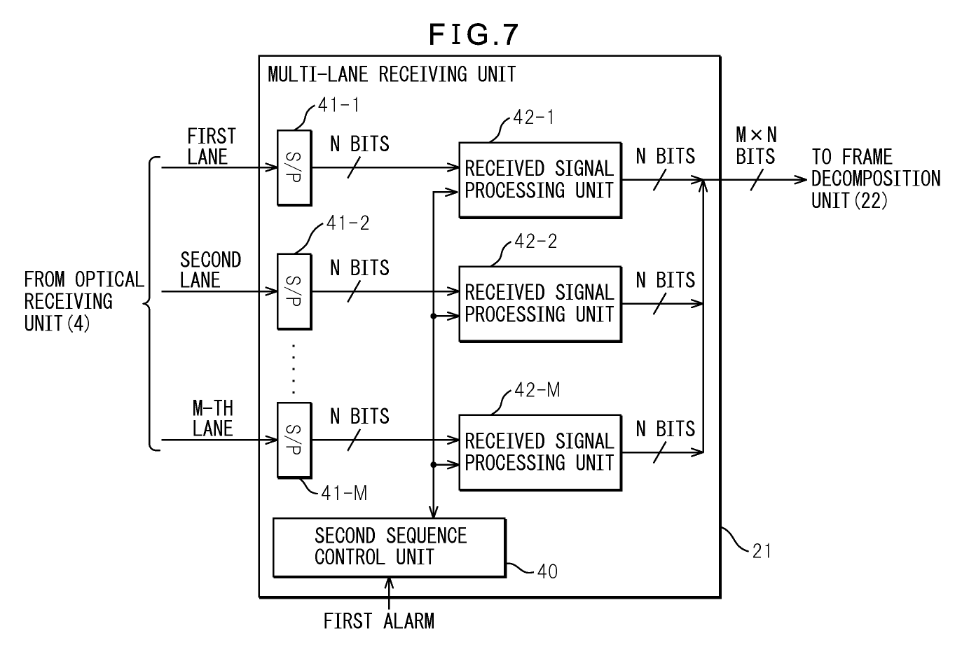

FIG. 7 is a diagram illustrating the first example of the configuration of the multi-lane receiving unit 21. The multi-lane receiving unit 21 includes a second sequence control unit 40, serial-to-parallel conversion units 41-1 to 41-M, received signal processing units 42-1 to 42-M. In the drawings and the following descriptions, a serial-to-parallel conversion unit may be referred to as “S/P.” In the following descriptions, the S/Ps 41-1 to 41-M may be collectively referred to as “S/P 41.” In addition, in the following descriptions, the received signal processing units 42-1 to 42-M may be collectively referred to as “received signal processing unit 42.”

The S/Ps 41-1 to 41-M convert the signals to be transmitted in the first lane to the M-th lane from a serial format to a parallel format. The parallel signals that are converted by the S/Ps 41-1 to 41-M are input in the received signal processing units 42-1 to 42-M, respectively.

The second sequence control unit 40 receives the first alarm signal from the frame decomposition unit 22. When receiving the first alarm signal from the frame decomposition unit 22, the second sequence control unit 40 starts the synchronization establishing sequence.

In the synchronization establishing sequence, the received signal processing units 42-1 to 42-M detect the synchronization signals received in the first lane to the M-th lane, respectively. Based on the phases of the detected synchronization signals, the received signal processing units 42-1 to 42-M adjust the phases of the partial signals to be transmitted by the first lane to the M-th lane.

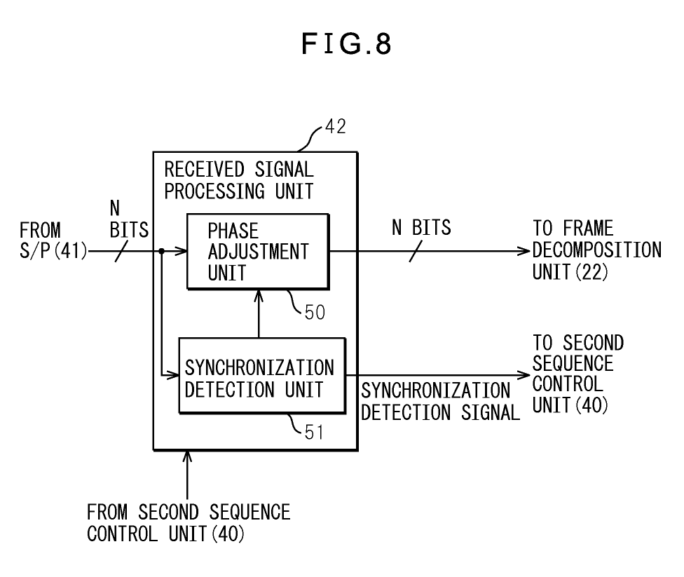

FIG. 8 is a diagram illustrating the first example of the configuration of the received signal processing unit 42. The received signal processing unit 42 includes a phase adjustment unit 50 and a synchronization detection unit 51. In the synchronization establishing sequence, the synchronization detection unit 51 detects the synchronization signal received in each lane. In other words, the synchronization detection unit 51 detects the synchronization signals from a plurality of partial signals separated by the optical receiving unit 4. Based on the phases of the detected synchronization signals, the phase adjustment unit 50 adjusts the phase of the partial signal to be transmitted in each lane. In other words, the phase adjustment unit 50 adjusts the phases of a plurality of partial signals separated by the optical receiving unit 4. The phase adjustment by the phase adjustment unit 50 may include, for example, bit alignment by the S/P 41. The bit alignment refers to the process of adjusting the bit positions according to which parallel signals are cut from a serial signal, in the S/P 41.

When synchronization is detected, the synchronization detection unit 51 outputs a synchronization detection signal, which indicates that synchronization is detected, to the second sequence control unit 40. When synchronization detection is finished in all lanes, the second sequence control unit 40 finishes the synchronization establishing sequence.

The multi-lane receiving unit 21 aligns M partial signals, to which phase adjustment has been applied in the received signal processing unit 42, and outputs the aligned signals to the frame decomposition unit 22.

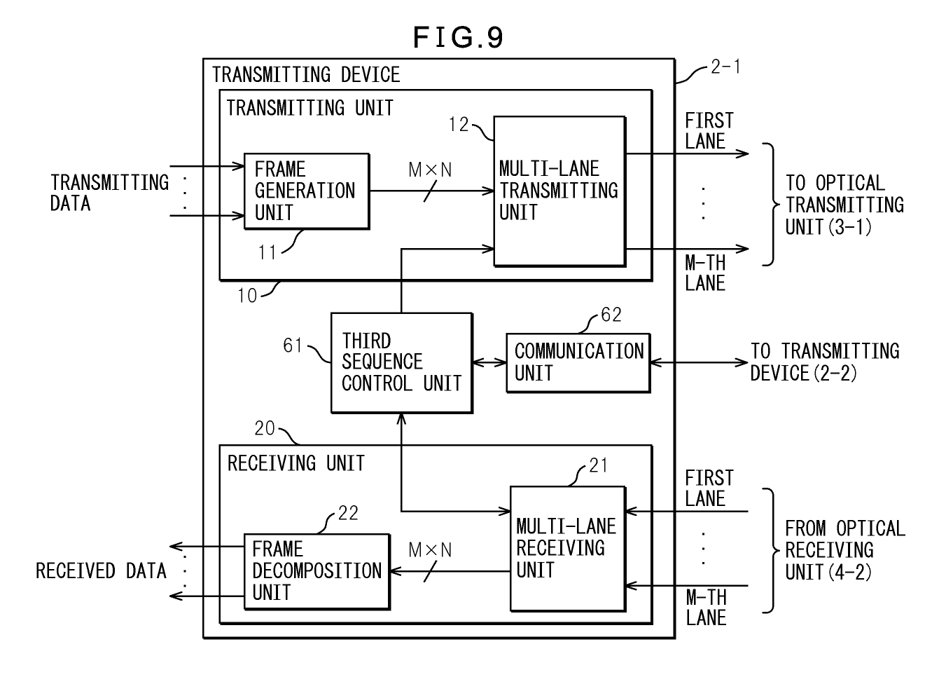

Next, another configuration example of the transmitting device 2 will be illustrated. FIG. 9 is a diagram illustrating another configuration example of the transmitting device 2. Components that are the same as the components illustrated in FIG. 4 and FIG. 5 will be assigned the same reference numerals as in FIG. 4 and FIG. 5. The transmitting device 2 may include a third sequence control unit 61 and a communication unit 62. The same applies to other embodiments illustrated herein.

In response to an input from the user, or at the time of starting the transmitting device 2, the third sequence control unit 61 automatically executes the synchronization establishing sequence. For example, the third sequence control unit 61 may include a CPU, a memory, and an auxiliary storage device that stores a computer program to execute the synchronization establishing sequence.

The communication unit 62 is connected to the communication unit 62 of the opposing transmitting device 2, and makes possible communication between the third sequence control units 61 of mutually opposing transmitting devices. When a sequence start command is received from the user, or when the transmitting device 2 is started, the third sequence control unit 61 starts the synchronization establishing sequence.

When the received signal processing unit 42 finishes synchronization detection in all lanes, the third sequence control unit 61 finishes the synchronization establishing sequence in the receiving unit 20. The third sequence control unit 61 reports to the third sequence control unit 61 of the opposing transmitting device 2 that the synchronization detection in the receiving unit 20 is complete. The third sequence control unit 61, being reported that the synchronization detection in the receiving unit 20 of the opposing transmitting device 2 is complete, finishes the synchronization establishing sequence in the transmitting unit 10.

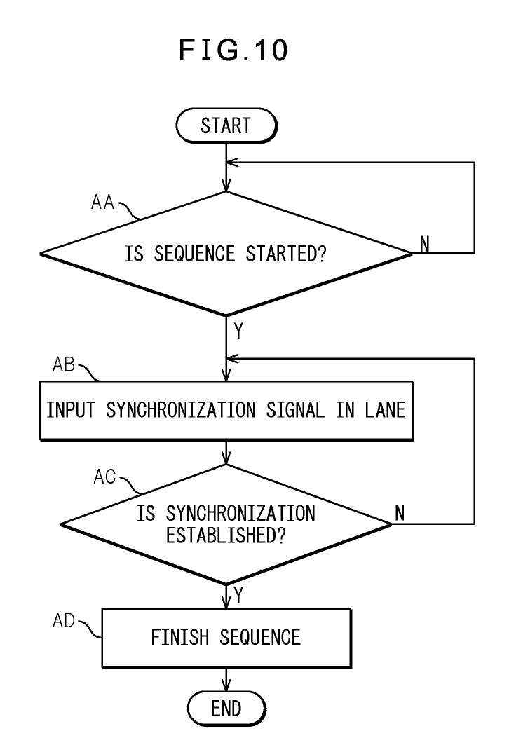

Next, the processes of the synchronization establishing sequence will be illustrated. In the following descriptions, the processes to be carried out when establishing the synchronization of a frame to be transmitted from the transmitting device 2-1 to the transmitting device 2-2 will be illustrated. FIG. 10 is a diagram illustrating the first example of the synchronization establishing sequence in the transmitting device 2-1. Note that, according to another embodiment, each operation of following operations AA to AD may be a step as well.

In operation AA, the first sequence control unit 30 or the third sequence control unit 61 decides whether or not to start the synchronization establishing sequence. For example, the first sequence control unit 30 may start the synchronization establishing sequence when receiving the second alarm signal from the frame decomposition unit 22. For example, the first sequence control unit 30 does not have to start the synchronization establishing sequence when the second alarm signal has not been received from the frame decomposition unit 22.

For example, when a sequence start command is received from the user or when the transmitting device 2 is started, the third sequence control unit 61 may start the synchronization establishing sequence. Furthermore, for example, the third sequence control unit 61 may decide not to start the synchronization establishing sequence when there is not the sequence start command from the user while the transmitting device 2 is operating.

When the synchronization establishing sequence starts (operation AA: Y), the process moves on to operation AB. When the synchronization establishing sequence does not start (operation AA: N), the process returns back to operation AA.

In the operation AB, the synchronization signal generation unit 31 generates synchronization signals. The signal switching unit 32 provides the synchronization signals, instead of the real signals, into the first lane to the M-th lane. In operation AC, the first sequence control unit 30 or the third sequence control unit 61 decides whether or not the synchronization of a received frame is established in the transmitting device 2-2.

For example, the first sequence control unit 30 may decide that the synchronization of the received frame is established when the second alarm signal from the frame decomposition unit 22 stops. While the second alarm signal from the frame decomposition unit 22 still continues, the first sequence control unit 30 may decide that the synchronization of the received frame is not established.

For example, when being reported from the third sequence control unit 61 of the transmitting device 2-2 that the synchronization detection in the receiving unit 20 of the transmitting device 2-2 is complete, the third sequence control unit 61 of the transmitting device 2-1 may decide that the synchronization of the received frame is established. When there is no report that the synchronization detection in the receiving unit 20 of the transmitting device 2-2 is complete, the third sequence control unit 61 of the transmitting device 2-1 may decide that the synchronization of the received frame is not established.

When the synchronization of the received frame is established (operation AC: Y), the process moves on to operation AD. When the synchronization of the received frame is not established (operation AC: N), the process returns back to operation AB. In operation AD, the first sequence control unit 30 or the third sequence control unit 61 finishes the synchronization establishing sequence.

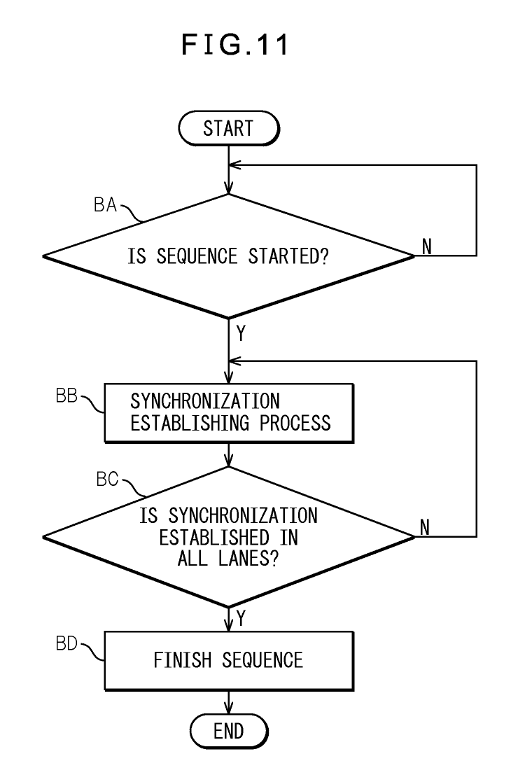

FIG. 11 is a diagram illustrating the first example of the synchronization establishing sequence in the transmitting device 2-2. Note that, according to another embodiment, each operation of following operations BA to BD may be a step as well.

In operation BA, the second sequence control unit 40 or the third sequence control unit 61 decides whether or not to start the synchronization establishing sequence. For example, the second sequence control unit 40 may start the synchronization establishing sequence when receiving the first alarm signal from the frame decomposition unit 22. For example, the second sequence control unit 40 does not have to start the synchronization establishing sequence when the first alarm signal has not been received from the frame decomposition unit 22.

For example, when a sequence start command is received from the user or when the transmitting device 2 is started, the third sequence control unit 61 may start the synchronization establishing sequence. For example, the third sequence control unit 61 may decide not to start the synchronization establishing sequence when, after the transmitting device 2 is started, there is not the sequence start command from the user.

When the synchronization establishing sequence starts (operation BA: Y), the process moves on to operation BB. When the synchronization establishing sequence does not start (operation BA: N), the process returns back to operation BA.

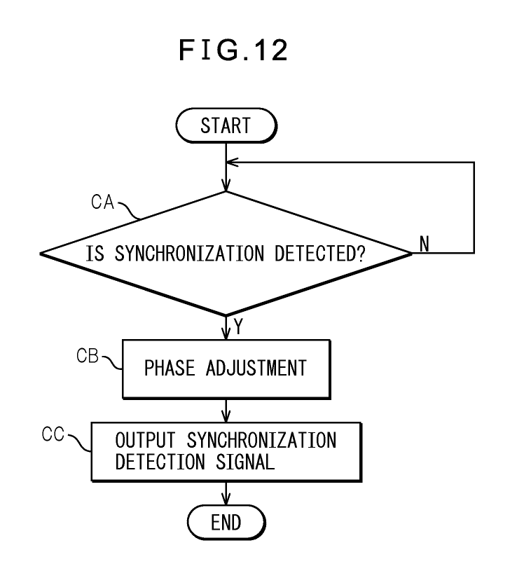

In operation BB, the received signal processing units 42-1 to 42-M perform the synchronization establishing process for the partial signals in the first lane to the M-th lane, respectively. The synchronization establishing process in each lane will be described below with reference to FIG. 12. In operation BC, the second sequence control unit 40 or the third sequence control unit 61 receives as input the synchronization detection signals that are output from each received signal processing unit 42, and decides whether or not synchronization is established in all lanes.

When synchronization is established in all lanes (operation BC: Y), the process moves on to operation BD. When synchronization is not established in all lanes (operation BC: N), the process returns back to operation BB. In operation BD, the second sequence control unit 40 or the third sequence control unit 61 finishes the synchronization establishing sequence. The third sequence control unit 61 reports, to the third sequence control unit 61 of the transmitting device 2-1, that the synchronization detection in the receiving unit 20 of the transmitting device 2-2 is complete.

FIG. 12 is a diagram illustrating the first example of the synchronization establishing process in the received signal processing unit 42. Note that, according to another embodiment, each operation of following operations CA to CC may be a step as well. In operation CA, the synchronization detection unit 51 tries to detect the synchronization of synchronization signals by detecting the known pattern included in the synchronization signals. When synchronization is detected (operation CA: Y), the process moves on to operation CB. When synchronization is not detected (operation CA: N), the process returns back to operation CA.

In operation CB, based on the phases of the detected synchronization signals, the phase adjustment unit 50 adjusts the phase of the partial signal transmitted in each lane. In operation CC, the synchronization detection unit 51 outputs the synchronization detection signals to the second sequence control unit 40.

With a conventional synchronization establishing method, the input lane for each OH of real signals is switched, and synchronization establishing process is performed in all lanes. With the communication system of the present embodiment, the synchronization of a frame is established by executing a specific synchronization establishing sequence in which synchronization signals are input instead of real signals. Consequently, with the communication system of the present embodiment, it is possible to input synchronization signals in an arbitrary lane in an arbitrary period. Consequently, with the present embodiment, it is possible to reduce the circuit scale by omitting a memory for switching the input lane for the OH.

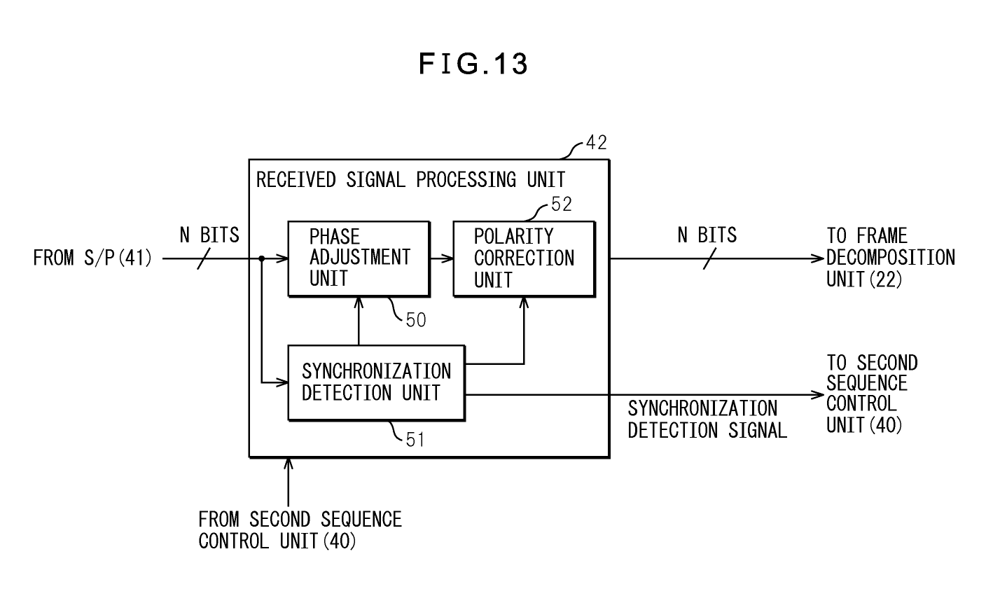

FIG. 13 is a diagram illustrating a second example of the configuration of the received signal processing unit 42. Components that are the same as the components illustrated in FIG. 8 will be assigned the same reference numerals as in FIG. 8. The received signal processing unit 42 includes a polarity correction unit 52. When the synchronization detection unit 51 fails to detect the known pattern from the synchronization signals, the synchronization detection unit 51 detects the inverted pattern of the polarity of the known pattern from the synchronization signal.

When the inverted pattern is detected, the synchronization detection unit 51 reports to the polarity correction unit 52 that the received signal is inverted. When the received signal is inverted, the polarity correction unit 52 inverts the polarity of the signal output from the phase adjustment unit 50 and outputs the signal to the frame decomposition unit 22.

With the communication system of the present embodiment, the polarity inversion of received signals is detected using synchronization signals that are transmitted in the synchronization establishing sequence instead of real signals. Consequently, with the present embodiment, it is possible to omit a memory for switching the input lane for the OH, which is used heretofore to detect the polarity inversion of received signals.

Next, another embodiment of the transmitting device 2 will be explained. FIG. 6 will be referenced. In the synchronization establishing sequence, the signal switching unit 32 selects one lane at a time from the first lane to the M-th lane in a specific order, under a control of switching operations in the SELs 34-1 to 34-M by the first sequence control unit 30, and inputs synchronization signals in one lane at a time. Alternately, the signal switching unit 32 may select one lane at a time from the first lane to the M-th lane in a specific order, by control of switching operations in the SELs 34-1 to 34-M by the third sequence control unit 61, and inputs synchronization signals in one lane at a time.

For example, the signal switching unit 32 may input synchronization signals in these lanes, in the order of the first lane, the second lane, the third lane . . . and the M-th lane.

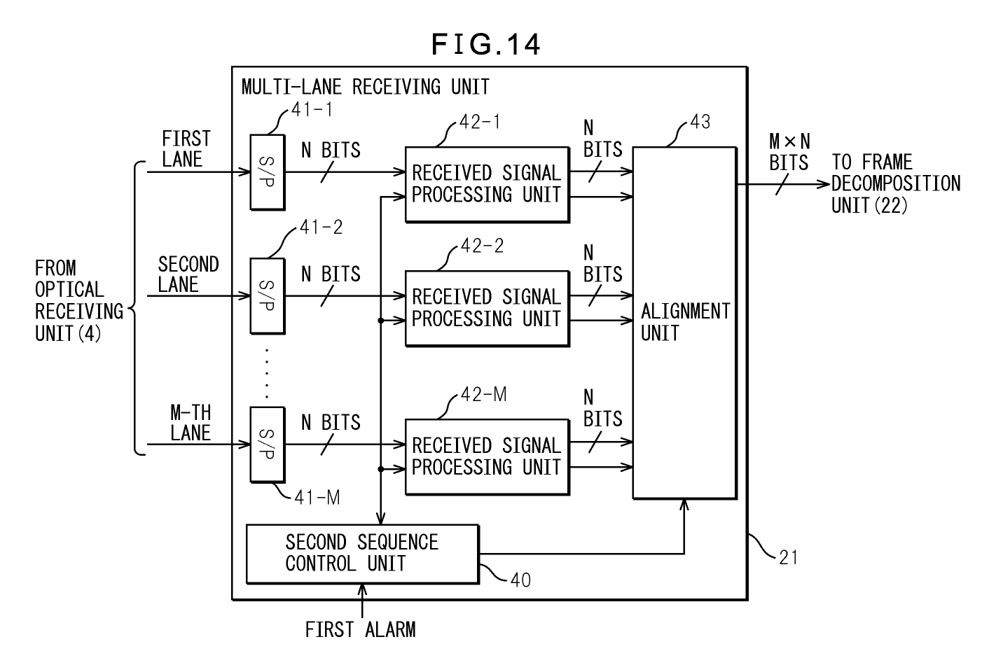

FIG. 14 is a diagram illustrating a second example of the configuration of the multi-lane receiving unit 21. Components that are the same as the components illustrated in FIG. 7 will be assigned the same reference numerals as in FIG. 7. The multi-lane receiving unit 21 includes an alignment unit 43. The multi-lane receiving unit 21 receives the synchronization detection signals that are output from each received signal processing unit 42. The synchronization signals are input in one lane at a time, so that the synchronization detection signals are also output from one received signal processing unit 42 at a time. The alignment unit 43 memorizes the order in which the received signal processing unit 42 detects synchronization.

The alignment unit 43 specifies the correspondence relationships between the lanes on the transmitting side where signals are input and the lanes on the receiving side where the signals are output, based on the specific order of lanes in which the signal switching unit 32 inputs synchronization detection signals, and the order of lanes in which the received signal processing unit 42 detects synchronization. The alignment unit 43 aligns the parallel signals that are input from the received signal processing unit 42, in an order of alignment to match the specific order of lanes in which the signal switching unit 32 inputs the synchronization detection signals. The alignment unit 43 may be, for example, a cross-connect switch. The aligned parallel signals are output from the frame decomposition unit 22.

For example, a case will be considered where, in the multi-lane transmitting unit 12, given parallel input signals of M×N bits, the partial signal of the first N bits is input in the first lane, the partial signal of the second N bits is input in the second lane, . . . and the partial signal of the M-th N bits is input in the M-th lane. In addition, assume that, for example, the specific order in which the signal switching unit 32 inputs synchronization signals in the first lane, the second lane, . . . and the M-th lane, is X1, X2, . . . and XM.

The alignment unit 43 aligns signals such that the signals to be output from the lanes where synchronization is detected the X1-th, the X2-th, . . . and the XM-th, become the parts of the first, the second, . . . and the M-th N bits in the parallel signals of M×N bits to be output to the frame decomposition unit 22.

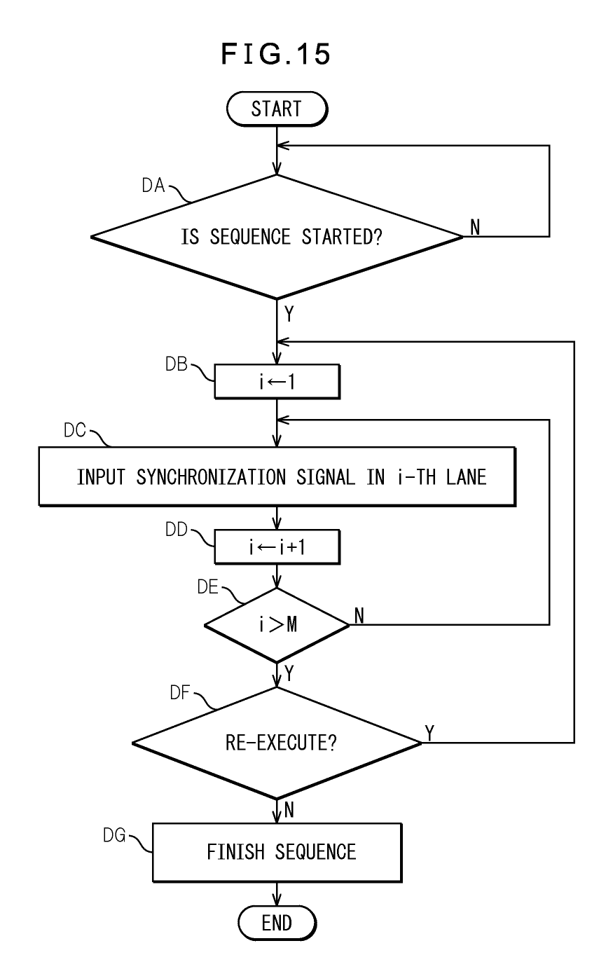

Next, the synchronization establishing sequence in the transmitting device 2 including the multi-lane receiving unit 21 depicted in FIG. 14 will be illustrated. In the following descriptions, the processes to be carried out when establishing the synchronization of frames that are transmitted from the transmitting device 2-1 to the transmitting device 2-2 will be illustrated. FIG. 15 is a diagram illustrating the synchronization establishing sequence in the transmitting device 2-1. Note that, according to another embodiment, each operation of following operations DA to DG may be a step as well.

In operation DA, the first sequence control unit 30 or the third sequence control unit 61 decides whether or not to start the synchronization establishing sequence. When the synchronization establishing sequence starts (operation DA: Y), the process moves on to operation DB. When the synchronization establishing sequence does not start (operation DA: N), the process returns back to operation DA.

In operation DB, the first sequence control unit 30 or the third sequence control unit 61 substitutes the variable i by 1. In operation DC, the synchronization signal generation unit 31 generates synchronization signals. The first sequence control unit 30 or the third sequence control unit 61 controls the SELs 34-1 to 34-M such that the synchronization signal is input in the i-th lane.

In operation DD, the first sequence control unit 30 or the third sequence control unit 61 increases the value of the variable i by 1. In operation DE, the first sequence control unit 30 or the third sequence control unit 61 decides whether or not the variable i is greater than the number of lanes M. When the variable i is greater than the number of lanes M (operation DE: Y), the process moves on to operation DF. When the variable i is equal to or less than the number of lanes M (operation DE: N), the process returns back to operation DC.

In operation DF, the first sequence control unit 30 or the third sequence control unit 61 decides whether or not to re-execute the synchronization establishing sequence. For example, the first sequence control unit 30 may decide to re-execute the synchronization establishing sequence when the synchronization signals have been input in all lanes and the process has reached operation DF and nevertheless the second alarm signal is still received. For example, the first sequence control unit 30 may decide not to re-execute the synchronization establishing sequence when the second alarm signal stops.

Furthermore, for example, the third sequence control unit 61 may decide to re-execute the synchronization establishing sequence when the process has reached operation DF and nevertheless completion of the synchronization detection in the receiving unit 20 of the transmitting device 2-2 is not reported from the third sequence control unit 61 of the transmitting device 2-2. The third sequence control unit 61 may decide not to re-execute the synchronization establishing sequence when being reported that the synchronization detection in the receiving unit 20 of the transmitting device 2-2 is complete.

When the synchronization establishing sequence is decided to be re-executed (operation DF: Y), the process returns back to operation DB. When the synchronization establishing sequence is decided not to be re-executed (operation DF: N), the process moves on to operation DG. In operation DG, the first sequence control unit 30 or the third sequence control unit 61 finishes the synchronization establishing sequence.

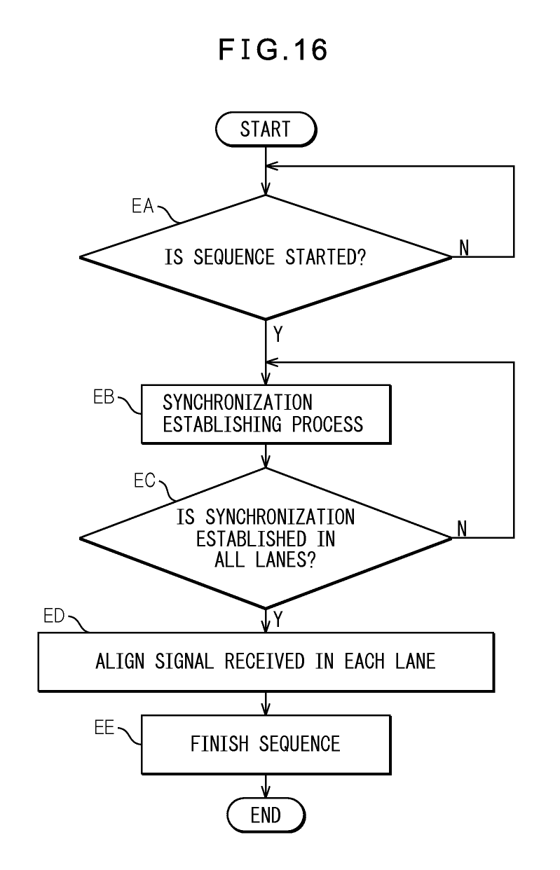

FIG. 16 is a diagram illustrating the synchronization establishing sequence in the transmitting device 2-2. Note that, according to another embodiment, each operation of following operations EA to EF may be a step as well.

In operation EA, the second sequence control unit 40 or the third sequence control unit 61 decides whether or not to start the synchronization establishing sequence. When the synchronization establishing sequence starts (operation EA: Y), the process moves on to operation EB. When the synchronization establishing sequence does not start (operation EA: N), the process returns back to operation EA.

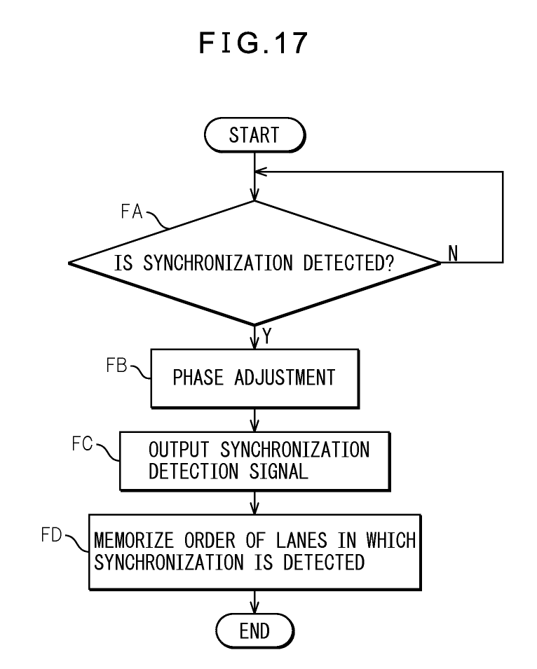

In operation EB, the received signal processing units 42-1 to 42-M perform the synchronization establishing process of the partial signals in the first lane to the M-th lane. FIG. 17 is a diagram illustrating a second example of the synchronization establishing process in the received signal processing unit 42. Note that, according to another embodiment, each operation of following operations FA to FD may be a step as well.

In operation FA, the synchronization detection unit 51 tries to detect the synchronization of synchronization signals. When synchronization is detected (operation FA: Y), the process moves on to operation FB. When synchronization is not detected (operation FA: N), the process returns back to operation FA.

In operation FB, based on the phases of the detected synchronization signals, the phase adjustment unit 50 adjusts the phase of the partial signal transmitted in each lane. In operation FC, the synchronization detection unit 51 outputs synchronization detection signals to the alignment unit 43. In operation FD, the alignment unit 43 memorizes the order in which the synchronization detection signals are output from the lanes.

FIG. 16 will be referenced. In operation EC, the alignment unit 43 decides whether or not synchronization is established in all lanes, by deciding whether or not synchronization detection signals have been output from the received signal processing units 42-1 to 42-M of all lanes.

When synchronization is established in all lanes (operation EC: Y), the process moves on to operation ED. When a period to complete inputting synchronization signals in all lanes passes and still synchronization is not established in all lanes (operation EC: N), the second sequence control unit 40 or the third sequence control unit 61 returns the process back to operation EB and re-executes the synchronization establishing sequence.

In operation ED, the alignment unit 43 aligns the parallel signals output from each lane, based on the specific order of lanes in which synchronization detection signals are input in the transmitting device 2-1, and the order in which the synchronization detection signals are output from the lanes.

The alignment unit 43 reports to the second sequence control unit 40 or the third sequence control unit 61 that synchronization is established in each lane. In operation EE, the second sequence control unit 40 or the third sequence control unit 61 finishes the synchronization establishing sequence. The third sequence control unit 61 reports to the third sequence control unit 61 of the transmitting device 2-1 that the synchronization detection in the receiving unit 20 of the transmitting device 2-2 is complete.

According to a conventional synchronization establishing method, the transmitting device on the transmitting side stores the identifiers of the lanes of the transmitting side in the OH of real signals and switches the lane to input the OH sequentially. The transmitting device on the receiving side detects the OH to store which identifier is output from which lane, and specifies the relationships between the signal input lanes on the transmitting side and the signal output lanes on the receiving side.

With the present embodiment, in the synchronization establishing sequence, the transmitting device on the transmitting side inputs synchronization signals sequentially, instead of real signals, in each lane, one lane at a time in a specific order. Then, the transmitting device on the receiving side specifies the relationships between the signal input lanes on the transmitting side and the signal output lanes on the receiving side, based on the order of lanes in which synchronization signals are input on the transmitting side and the order of lanes in which synchronization is detected on the receiving side.

Consequently, according to the present embodiment, it is possible to omit switching of the input lane for the OH, which has been used to specify the relationships between the signal input lanes on the transmitting side and the signal output lanes on the receiving side. Consequently, with the present embodiment, it is possible to omit a memory for switching the input lane for the OH.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A synchronization establishing method for establishing frame synchronization in a communication system in which one frame is divided into a plurality of signal blocks, the plurality of signal blocks are transmitted in parallel and after that multiplexed and transmitted as a multiplex signal, and a plurality of signal blocks, acquired by separating the received multiplex signal, are transmitted in parallel and after that combined and formed into a format of the frame, the synchronization establishing method comprising:
executing a sequence for establishing synchronization of the frame,
wherein the sequence comprises:
inputting synchronization signals in the plurality of signal blocks that are multiplexed in the multiplex signal;
detecting the synchronization signals from the plurality of signal blocks that are separated from the multiplex signal; and
adjusting a phase of each of the plurality of signal blocks that are separated, based on phases of the detected synchronization signals.

2. The synchronization establishing method according to claim 1, wherein the sequence comprises:
inputting the synchronization signals in the plurality of signal blocks that are multiplexed in the multiplex signal, in a specific order; and
aligning the plurality of signal blocks that are separated, in an order of alignment to match the specific order, based on an order of detection in which the synchronization signals are detected from the plurality of signal blocks that are separated.

3. The synchronization establishing method according to claims 1, comprising:
detecting synchronization of the frame; and
executing the sequence when the frame is out of synchronization.

4. A receiving device for receiving a multiplex signal, in which a plurality of signal blocks, acquired by dividing one frame, are transmitted in parallel and after that multiplexed, the receiving device comprising:
a separation unit which separates the multiplex signal into a plurality of signal blocks;
a sequence control unit which starts and finishes a sequence for establishing synchronization of the frame;
a synchronization detection unit which, in the sequence, detects synchronization signals, which are input in the plurality of signal blocks that are multiplexed in the multiplex signal, from the plurality of signal blocks that are separated from the multiplex signal; and
a phase adjustment unit which adjusts a phase of each of the plurality of signal blocks that are separated, based on phases of the synchronization signals.

5. The receiving device according to claim 4, further comprising an alignment unit which aligns the plurality of signal blocks that are separated, in an order of alignment to match the specific order, based on an order of detection in which the synchronization signals are detected from the plurality of signal blocks that are separated, wherein the synchronization signals are inputted in the plurality of signal blocks that are multiplexed in the multiplex signal in a specific order.

6. A transmitting device for transmitting a multiplex signal, in which a plurality of signal blocks, acquired by dividing one frame, are transmitted in parallel and after that multiplexed, the transmitting device comprising:
a sequence control unit which starts and finishes a sequence for establishing synchronization of the frame, in a receiving device that receives the multiplex signal;
a synchronization signal generation unit which generates a specific synchronization signal; and
a signal switching unit which, in the sequence, inputs synchronization signals in the plurality of signal blocks that are multiplexed in the multiplex signal.

7. The transmitting device according to claim 6, wherein the signal switching unit inputs the synchronization signals, in the plurality of signal blocks that are multiplexed in the multiplex signal, in a specific order.
